(19) United States
(12) Patent Application Publication
(10) Pub. No.: US 2008/0189558 A1
(43) Pub. Date: Aug. 7, 2008

(54) System and Method for Secure Data Storage

(75) Inventors: James P. Hughes, Palo Alto, CA (US); George R. Nelson, Hants (GB)

Correspondence Address: BROOKS KUSHMAN P.C. / SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 11/670,059

(22) Filed: Feb. 1, 2007

(51) Int. Cl. G06F 12/14

(52) U.S. Cl. 713/193

(57) ABSTRACT

A system and a method for secure data storage includes one or more data storage devices. A storage area network places the one or more data storage devices in communication with one or more user interfaces. A secure data solution includes a log structured driver interfacing with the one or more data storage devices to encrypt and secure data stored thereon. The log structured driver encrypts and decrypts data into a plurality of segments created on the one or more data storage devices. The system includes a traffic masking pattern that is used to obscure activity on the system from potential attackers.

### BACKGROUND OF THE INVENTION

1. Field of the Invention

The present invention relates to a system and method for providing secure data storage.

2. Background Art

Traditional (i.e., conventional) data file storage systems have four main focus areas, free space management, access control, name and directories (i.e., name space management) and local access to files. As data grows exponentially over time, storage management becomes an issue for all Information Technology (IT) managers. When a storage area network (SAN) is deployed, managing storage resources efficiently becomes even more complicated.

Conventional file systems are typically implemented to provide network-oriented environments as scalable and network-aware file systems that can satisfy both data storage requirements of individual systems and the data sharing requirements of workgroups and clusters of cooperative systems. Increasingly, information produced by one client must be shared by other clients connected through a computer network. The information may be kept on one or more storage systems also connected to the network. Such networks often interconnect many clients throughout an organization, some of whom are excluded from access to the information. The network may also support connections to public networks, such as the Internet, providing the possibility of unauthorized access from outside of the organization.

Storage systems used to hold shared information may include disk arrays for short term, high speed access of information, tape management systems for long term, high volume storage, and other types of storage devices. Such storage systems are often managed by centralized information systems groups which neither produce nor consume the information. These information systems groups are responsible for the security and integrity of information stored within the storage systems, and often have access to the stored information.

Certain types of information produced and used within an organization must be kept secure. This information includes financial figures, personnel data, health information, business plans, trade secrets, and the like. A client producing such information should be able to store this information in an untrusted storage device in a manner that permits authorized clients to access the information while denying access to all others, including host managers and information systems personnel.

Data storage solutions may be susceptible to attacks from individuals attempting to gain access to stored data. Attacks on data storage networks may come in various forms. For example, a passive attack occurs when the attacker has no ability to access the ciphertext on the disk without the user's knowledge. That is, the data is stored on the disk in an encrypted form and if the disk is lost or stolen, the attacker gains a snapshot of the data.

An active attack occurs when the attacker has access to the ciphertext on the disk and the ability to read and write the ciphertext. Obviously, this more prevalent on a SAN than on a personal computer (PC). However, this type of attack could be mounted as an attack where the attacker removed the disk, tampered with the data and then put the disk back. If the attacker can mount an active attack, they can rearrange the data, or tamper with the bits. Encryption without authentication and integrity can be susceptible to the ciphertext being malleable.

There are several disk and tape encryption hardware and software that provide privacy and can be considered secure to passive attacks. Some of these operate at the sector level and others operate at the file system level as both hardware and software solutions. One limitation of such systems is that they provide limited privacy protection. Since tampered ciphertext is not detected, the best option these solutions provide is to randomize the data for protection.

There are other encrypted storage systems that provide integrity checks where active attacks can be detected and the possibility of corrupted information can be avoided. Most of these are file systems that include integrity checks at the object (file) level. In cases of both passive and active attacks, these systems make no attempt to hide the traffic from traffic analysis.

The security risks of local area networks (LAN) traffic analysis is a known issue. However, traffic analysis of SAN solutions is not well defined. Some examples of an attacker's ability to track encrypted streams transferred to and from a disk drive include when user arrives at desktop machine in the morning, if the machine being booted and when and what application is being loaded by the drive.

The attacker can use these hints to determine what is being done in the encrypted partition, or even how to circumvent the protection that the users of encrypted storage are trying to preserve. One can also use trends of activity by a system administrator to denote lower or higher scrutiny of the system's users. In this sense, traffic analysis of the SAN traffic to encrypted disks leaks significant amounts of information both in the sector location that is written to and the timing of these requests are enough to provide hints about what is being read/written.

### SUMMARY OF THE INVENTION

A system and a method for secure data storage. The system includes one or more data storage devices. A storage area network places the one or more data storage devices in communication with one or more user interfaces. A secure data solution includes a log structured driver interfacing with the storage devices to encrypt and secure data stored on the storage unit. The log structured driver encrypts and decrypts data into a plurality of segments created on the one or more data storage devices. The system includes a traffic masking pattern that is used to obscure activity on the system from potential attackers.

The above features, and other features and advantages are readily apparent from the following detailed descriptions thereof when taken in connection with the accompanying drawings.

### BRIEF DESCRIPTION OF THE DRAWINGS

FIG. 1 is a diagram of a typical storage area network solution;

FIG. 2 is a diagram showing the interrelation of the secure storage driver for use with the operating system and disk driver in a storage area network;

FIG. 3 is a diagram of the layout of a formatted disk for use with the driver;

FIG. 4 is a diagram of the format of one of the segments stored on the formatted disk;

FIG. 5 is a diagram illustrating the implementation of the secure storage driver in a traffic masking pattern for use in connection with the storage area network solution; and

FIG. 6 is a diagram showing the subsystems of the log structured driver.

### DETAILED DESCRIPTION OF THE PREFERRED EMBODIMENT(S)

With reference to the Figures, an improved system and method for securely storing data. Encrypted file systems encrypt the objects themselves and leave much of the meta data intact. Things like access and modification times are in the clear and available to passive attacks. Active attacks can be thwarted though the use of authentication and integrity checks at the file and even the tree of files, but the access pattern, which is available to an attacker sniffing the SAN or disk traffic or taking snapshots of the file system itself can not be protected. A sector level solution that masks all file and file system operations can mask the operations of one file or another as well as the metadata itself.

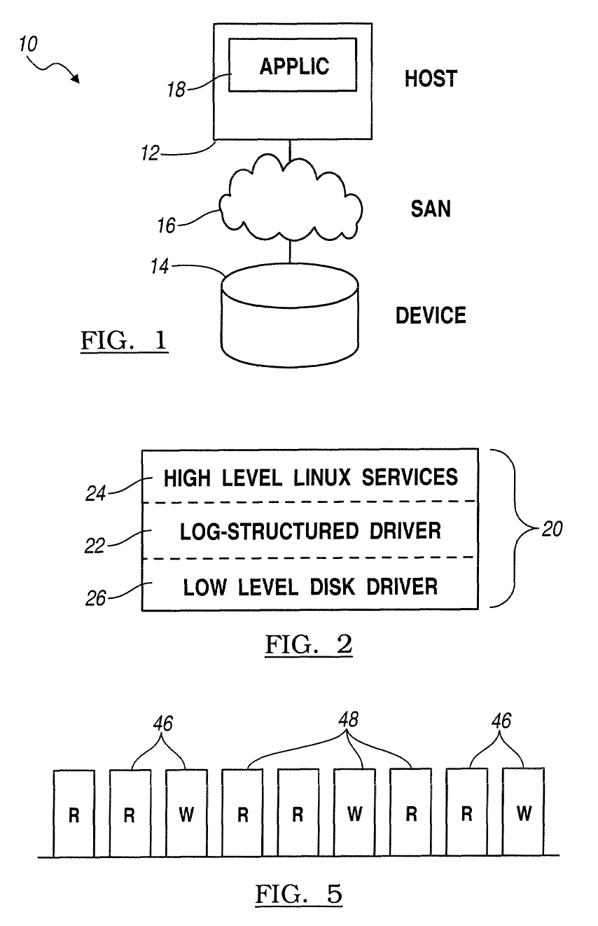

Referring now to FIG. 1, a diagram of a high level system architecture of a system 10 is shown. The system 10 is generally implemented as a scalable data storage system. The system 10 is generally implemented as a virtual library system or virtual file system (VFS). The virtual file system 10 may include components such as a meta data subsystem, an object or file subsystem, a data storage (e.g., tape/disk) subsystem and an administration subsystem. As illustrated in FIG. 1, system 10 generally includes a user interface host computer 12 interconnected to a storage device 14 through a storage area network (SAN) 16. Host computer 12 may include an application 18 that allows for interconnectivity with the SAN 16.

System 10 incorporates a solution for evaluating and securing the system 10 against passive, active and traffic analysis attacks. In one aspect, the solution may be loaded on the host computer and associates with the application 18 on the host computer 12 that is reading or writing the data, in the storage area network 16 and/or in the storage device 14.

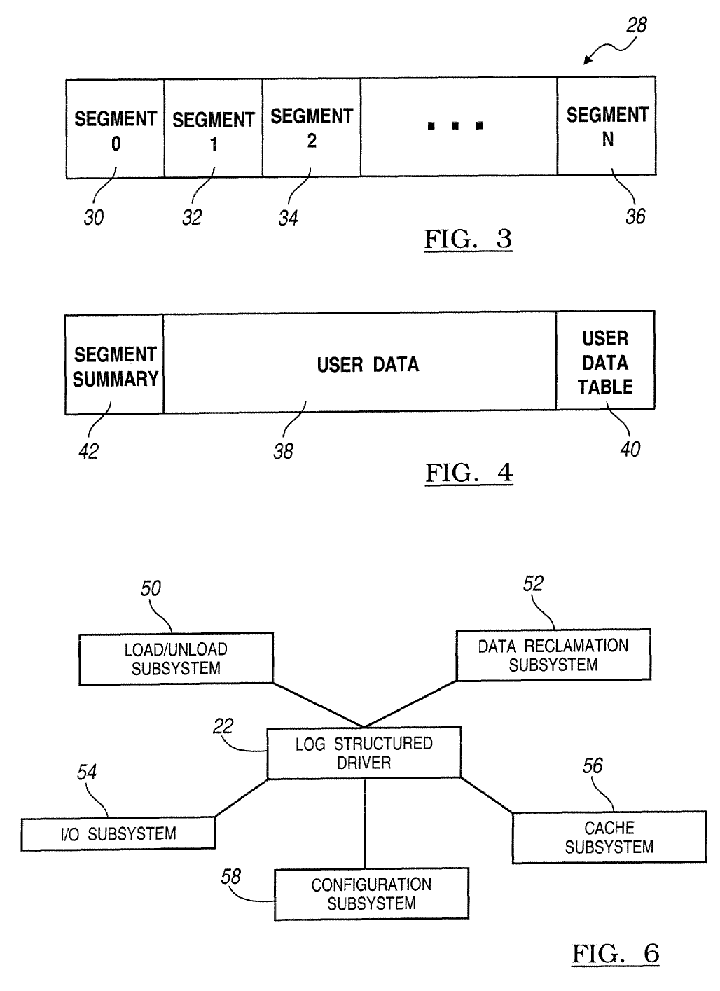

Referring now to FIG. 2, a diagram of one implementation of the secure data solution of the system and method is illustrated. Solution 20 implements a logical device driver or log structured driver 22 residing in kernel space and interfaces between the higher-level operating system, for example a virtual file server (VFS) 24 and the lower level disk drivers 26. This implementation is currently targeted for a Linux platform kernel, although it can be implemented on any platform. Driver 22 may be a pseudo driver that provides a pass-through service to the disk driver 26, encrypting and decrypting the data in the process. In addition, it treats the real disk driver 26 similar to an infinite spool of tape, that is, all writes proceed sequentially through the real disk. Hence, there is no over-writing of data blocks. To support this log structuring and simplify the encryption and decryption process, the log-structured driver 22 divides the real disk 26 into a number of fixed size areas called segments as shown in FIGS. 3 and 4.

Referring additionally now to FIGS. 3 and 4, disk 26 is preformatted prior to use by the log structured driver 22. It is understood that the size of a segment 28 is fixed when the disk is formatted. However, this is an option of the formatting utility incorporated in the system 10. In one embodiment, the sizes of segments 28 are limited to be powers of 2 in size with a maximum size of 2 megabytes (MB). The upper limit is dictated by the need for a contiguous input/output (I/O) buffer and operating system platform limits of 2 MB. It is also understood that a lower limit of 128 kilobytes (KB) is imposed on the size of the segments 28 for efficiency purposes.

Referring now to FIG. 3, one or more segments are reserved by the solution to contain meta data that specifies the layout of disk 26. In one embodiment, at least one segment, in this figure segment 0 30, is reserved to contain global meta data that describes the disk layout. This meta data contains the segment size, real disk size, last segment written and a segment usage table consisting of one entry per segment. For larger capacity disks, more than one segment may be needed to hold this global meta data.

The number of global meta data segments is a function of the disk and segment sizes. Further global data areas to handle disk corruption can also be created when the disk is formatted. These segments can be spread at fixed intervals through the disk 26. The remaining segments, such as segment 1 32, segment 2 34 and segment n 36 hold user data and the volatile metadata that is needed to handle I/O operations.

Referring now to FIG. 4, the format of each segment 28 is shown and described herein. The user data area 38 of segment 28 contains user data blocks and B-tree nodes. The user data table 40 is used to hold information about each of the blocks, such as the user or B-Tree that are contained in the user data area 38. This information is used both for crash recovery and data reclamation or garbage collection. Finally the segment summary 42 contains meta data describing the segment 28, the location of the root B-Tree node and the information needed to encrypt or decrypt the segment 28.

The host system has no knowledge of the log-structuring and will present the same logical block address to the encryption solution for a particular block of user data. It is the responsibility of the log-structured driver to maintain the relevant information to retrieve the current version of this data, modify the block address accordingly and make the I/O request. This mapping is performed using a B-Tree where the search is carried out using a combination of the logical block number (LBN) and the real disk device identification (ID). Any user data write will cause an update to this mapping between LBN and actual sector address. This will cause an update to one or more nodes in the B-Tree since the log-structured mode applies to B-Tree nodes a well as user data.

When the segment 28 is written to capacity, all the data resident in the segment 28 is encrypted as it is moved into the segment buffer. Each of the three areas in the segment summary 44 are encrypted independently, although the segment summary data maintains the necessary information needed to decrypt each area. The segments may be written as a single write request after encryption is completed or as multiple write requests.

Referring again to FIG. 2, the log structured disk 22 allows data to be written without the necessity of matching to a logical location on the disk to assist in compression and to alleviate concerns with respect to possible overwrite issues. Further, log structured disk allows for a snapshot of the data to take place, whereby the snapshot is a perspective of the logical data from an earlier position in the log. The mechanisms of a log structure disk is to batch up the writes into segments. These segments can be hundreds of kilobytes in size and contain a complex structure of the customer's data and the meta data to preserve the logical representation of the virtual disks. It is understood that data that is written by applications at a similar time, regardless whether it is at a similar location on the disk, will end up in the same segment.

Log structure disk 22 includes the addition of an extension of additional encryption where each segment is encrypted and authenticated using standard techniques. This includes the ability of creating nonces and authentication tags. Thus, no matter how many times the data is written to disk ciphertext will never repeat. Whenever information is needed out of a segment, it is retrieved and the authentication of the entire segment is checked and the entire segment's decrypted contents is cached.

It is understood that log structured disks have limitations on storage capacity. The overwritten sectors are harvested in a data reclamation or garbage collection process that takes segments with a small number, anywhere from zero to n number of active sectors and, after moving any active sectors to the current segment, marks the old segment as free. Use of this data reclamation process masks data transfer patterns to a potential attacker. There is no physical difference between a demand read of a data segment or a garbage collection read, and there is no visibility to the attacker of the ratios or even numbers of new or harvested sectors being written in a segment.

Referring now to FIG. 5, a diagram of an exemplary traffic masking pattern used in the system is shown. Traffic masking is a process that ensures that the traffic pattern of reads and writes occur at some pattern to reduce the likelihood that an attacker could determine the activity on the SAN.

The solution attempts to resolve several examples of an attacker watching an encrypted SAN stream of data going to and from a disk drive to determine, among other issues, when user arrives at and leaves a desktop machine, if the machine being booted, when and what application is being loaded and/or if an file that was written a year ago is being overwritten. While this information may seem trivial, it is the kind covert or side channel that the can to use as hints on what is being done in the encrypted partition, or even how to circumvent the protection that the users of encrypted storage are trying to preserve. One can also use trends of activity by a system administrator to denote lower or higher scrutiny of the system's users. In this sense, traffic analysis of the SAN traffic to encrypted disks leaks significant amounts of information both in the sector location that is written and the timing of these requests are enough to provide hints about what is being read/written.

Traffic masking may include a two step process. A first step includes removing jitter by delaying the read and write requests of the normal operation and garbage collection as shown by reference numeral 46. The second step includes the addition of traffic as shown by numeral 48 to make up the dead time between the read/write process. The additional traffic can be reads anywhere on the disk, and the writes can be empty or partial segments. In another aspect, a similar process may be conducted by having the data reclamation or garbage collection task run constantly, thereby harvesting data from segments.

The address of the activity can look random to the attacker since any write can occur to any unused segment, and reads can be to any used or unused segment. For example, this traffic masking can be a fixed pattern where a two reads and one write occur every 100 milliseconds (ms) as illustrated in FIG. 5, or in some random pattern where traffic has a random nature where the average wanders. This adjustment of the traffic masking process may allow for higher averages during peak activities.

In another aspect of the invention, it is possible to make the traffic masking optional with three levels of activity. The first level would be no traffic masking. In this level, the attacker will see the traffic as it happens. It is possible that the attacker may determine, based on the timings of read/write events, whether a particular activity has occurred to develop a pattern of data exchange.

The second level would be a jitter removal of data. In this level, the attacker will see the traffic as it happens. However, the read/write pattern would be delayed to a specific pattern for use and/or data reclamation or garbage collection. If there is no activity on the system, there will be no traffic to analyze. Thus, it is possible that the attacker might be able to determine, based on the read/write timings, whether a particular activity has occurred before. The third level is a complete traffic masking. In this case, the attacker will see constant traffic on the system. Thus, the attacker will not be able to determine, based on the read/write timings, whether there is any actual activity occurring at that time.

Another aspect relates to the security provisions of the solution. The disk driver can use anything for the nonce, and it is simplest to keep a counter (which is ECB encrypted) so that this is not information that the attacker can access. It is possible to have one sequence space for the in use segment and another for unused segments so that masked traffic and normal traffic are indistinguishable and never repeat. The information on the disk may be encrypted nonce, tag, or ciphertext, all of which is indistinguishable from the other.

It is understood that a single physical partition can have a single symmetric cipher key that is sufficient for this solution. Revoking a key and re-key can be accomplished in two ways. A first way includes copying the data to another partition and then destroying the previous partition. A second method includes changing the key midway through the logging process, remembering which blocks use which key, and using garbage collection to migrate the old data to the new key. The garbage collection process then destroys the new key while making sure that all old key data is overwritten. Mid log re-keying can function under the traffic masking but will take longer.

Referring now to FIG. 6, a further description the subsystems of the log structured driver 22 used in the system is described in greater detail. It is understood that driver itself may be implemented as a loadable kernel module. In one aspect, there is a one-to-one correspondence between a log structured disk and a real disk, although there can be multiple log structured disks associated with a single real disk.

Log structured driver 22 includes a load/unload subsystem 50 that manages the initialization process on the module load. Subsystem 50 calls the initialization functions for each of the other subsystems. Once load is completed, the operating system can reclaim any of the initialization data and code sections used. An unload process requests the shutdown functions, ensuring that subsystems are shutdown in the correct order. Once the module load is complete, there are a number of /proc entries created that allow global configuration of the driver operational parameters. These may include the maximum size of the various pools, their low and high management levels and the sleep intervals for the garbage collection and memory threads.

The garbage collector subsystem 52 runs as a separate thread and recovers segments from the disk that contain stale data, for example, user data that has been superseded. The thread sleeps for most of the time, waking at fixed intervals or when the number of free segments crosses a low water threshold.

The garbage collector thread runs at intervals or when the number of free segments falls below a minimum level. If there are sufficient free segments, the thread just goes back to sleep. However, when the number of free segments approaches or crosses the minimum level it will read segments from the oldest segment and examine each user block within the segment. Stale blocks (the current mapping does not correspond to the same real sector address) in the segment are counted, and if the count exceeds a given level then the remaining (active) blocks are written to the current segment (as if this was a user data write) and the segment is then marked as free. The thread continues to run until either sufficient segments have been returned or all segments have been examined.

The I/O subsystem 54 includes at least two threads for each device supported by the log-structured driver 22. The first of two threads is a pre-processing thread that deals with inbound I/O requests allocating all necessary resources and issues the segment I/O requests as required, encrypting the segment data on segment writes. The second of two threads is a postprocessing thread that deals with completion of the segment I/O requests and may include decryption of the user data.

For each real device there is a pre-processing and post-processing thread. When the module is loaded and the logical-to-real association created, the I/O initialization function is called to create these threads. In addition, the global meta data is read from the real disk to obtain all the necessary global meta data needed to allocate the I/O resources required and initialize the encryption data for this disk. Once completed, the device is ready to accept I/O requests (prior to this point any attempt to open the logical disk device will result in an error).

The pre-processing thread receives read/write requests from the user. The first operation is to check the cache to see if the data exists in the cache. If it does and it is a read request, then the request returns the cached data, otherwise a B-Tree lookup is made to find the real sector address for the data and an I/O request issued to read the segment that contains the required user block. The thread then sleeps until the request completes and the required data block is available. This is then returned to the user.

If the request is a write request, and the user data block exists in the current segment buffer, then it replaces that data with the new data, otherwise the user data block is added to cache and linked to a list of dirty blocks that are to be written to the current segment buffer. When the list indicates that the current segment buffer is full, the dirty list is processed and each data block encrypted into the segment buffer. The buffer is queued to be written and a new buffer allocated. In addition to user read/write requests there can be internal read/write requests. For example the garbage collector will issue read requests to reclaim disk space. Also there will be meta data read requests during initialization and meta data write requests during normal operation.

All read and write requests are in segment size lengths. On completion, the request is queued to the post-processing thread and this is woken up. When the read/write request was issued, part of the I/O request data maintained is the address of the post-processing function that is called by the post-processing thread. These functions deal with the action appropriate for the type of read or write request. Segment reads will decrypt the segment then wakes up the thread that issued the read. If the read was cause by a user read request, the segment is queued to the cache thread so the remaining data in the segment can be added to cache. Completion of segment writes simply returns the buffer to its pool.

Cache subsystem 56 handles the I/O cache and memory functions. This subsystem may include at least one thread. In one aspect of the invention, subsystem 56 includes three threads: a memory allocation thread, a memory release thread and a cache thread. The cache thread implements a hash cache that contains user data blocks as well as B-Tree nodes. The driver caches data in 4 KB blocks which allows the use of high memory as an available memory resource, resulting in a much larger data cache.

The memory allocation and memory release threads deal with allocation and release of memory resources as required. This includes segment buffers, cache structures and I/O request structures. Each of these are organized in pools that the memory threads attempt to maintain within low and high management levels. Requests for memory are queued to the memory allocation thread when the required pool is empty. When the various data structures are no longer required, they are queued to the memory release thread to either return them to the appropriate pool or to the system.

Cache subsystem 56 handles both memory and cache management. The cache is implemented as a hash table and each entry relates to a block of user data. User data blocks can be restricted to 1 KB, 2 KB or 4 KB sizes or can be variably adjusted. Regardless of block size, each cache entry points to a 4 KB page in high memory. In addition to user data blocks, B-Tree nodes are also cached. This reduces the number of segment reads needed to get B-Tree nodes during a B-Tree lookup operation. It is expected that the cache will contain all nodes in a B-Tree unless memory becomes scarce. Initialization at module load will create a pool of cache entries so that new items can be added to the cache quickly.

At initialization the memory allocation and release threads are created along with memory pools for I/O request structures, cache entries and segment buffers. The memory allocation thread will normally run at intervals to check the state of each of these pools and try to replenish them to at least their low water level. However it can also be awoken when any of the subsystems returns memory to a pool or the system.

When a memory resource used by the driver is no longer needed, it is queued to the memory release thread and this thread is woken up. In most cases this will result in adding the resource to its memory pool but may cause a search for memory if memory pools are low. The search will reduce any pools that have exceeded their high water level back to the high water level, and release cache entries that have not been accessed in a given time period.

Configuration subsystem 58 provides the dynamic addition and removal of both logical and real disks. This, in addition to providing/proc entries into the driver that give various details on driver operation, also supports a simple proc file system. The operations supported on the proc file system include directory and block special file creation. The proc file system is very similar to the random access memory (RAM) disk file system but with reduced functionality. After the logical driver is loaded, this file system can be mounted.

This subsystem supports both /proc entries and the file system that allows mapping of logical disks to real disks. When such an association is made via a mknod system call, the file system allocates a logical device specific data structure and creates the pre- and post-processing threads to deal with I/O to the real disk. Further it creates logical disk specific /proc entries to allow the encryption seed and AES length to be supplied. The /proc entries are created in a tree structure. The root of the tree contains the global configuration entries and a number of subdirectories related to the real disks in use. Each subdirectory contains /proc entries related to the specific real disk as well as directories for each logical disk that has been associated with the real disk. The logical disk directory contains /proc entries related to the logical disk. The file system creates a directory structure at the mount point root that mirrors the /proc structure that is set up. Although not required, this simplifies tracking and maintaining the device associations.

Association between a logical disk name and a real device is done by treating a block special file on this file system via a mknod command. The major and minor numbers to this command would be those referring to the real disk device. Execution of the mknod command causes the file system to set up all data structures needed to handle the logical to real disk association. Although the major and minor numbers for the mknod command are those of the real disk device, the block special file created will be a logical disk (the major and minor number is changed to a unique values for the logical disk).

Once the logical disk special file is created in the proc file system, the remaining configuration relating to that logical disk can be supplied through /proc entries created by execution of the mknod command. Amongst other things this includes the encryption seed and the AES encryption length needed to encrypt/decrypt data on the associated real disk.

Encryption may be effected using a number of algorithms, including the AES-OCB encryption algorithm and a modified version thereof. In one embodiment, the modified encryption algorithm encrypts or decrypts data a segment at a time. However both meta data segments and user data segments are encrypted in two separate passes. For meta data segments, the segment usage table is encrypted first and the resultant checksum stored in the global meta data area. This information is then encrypted apart from the first few words that contain the nonce for this segment and its checksum.

These two pieces of data are the pieces of in the clear data for meta data segments. A similar situation holds for user data segments: first the user data area is encrypted, then the user data table and their checksums stored in the segment summary area. This is then encrypted leaving only the nonce for this are and its checksum in the clear. During decryption the process is reversed to get the plain text checksums for the remaining area(s).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for secure data storage, the system comprising:
one or more data storage devices;
one or more user interfaces in communication with the one or more data storage devices through a storage area network; and
a data solution for securing data retained on the one or more data storage devices, the solution including log structured driver interfacing with the storage devices to secure data stored on the one or more storage devices to encrypt and decrypt data into a plurality of segments created on the one or more data storage devices,
wherein a traffic masking pattern is used to obscure activity on the system from potential attackers.

2. The system according to claim 1 wherein the log structured driver further comprises:
a load/unload subsystem that initializes activation of the log structured driver;
a configuration subsystem defining the information needed to provide the association between the log structured driver and the one or more data storage devices;
an I/O subsystem that creates threads between the log structured driver and one or more data storage devices;
a cache subsystem implementing a hash table that links blocks of user data to data in segments; and
a data reclamation subsystem that runs when the number of free segments on the one or more storage devices falls below a predetermined level.

3. The system according to claim 2 wherein the configuration subsystem creates a block special file on the storage device to create the association between the log structured driver and the one or more storage devices.

4. The system according to claim 2 wherein the I/O subsystem further comprises:
a pre-processing thread that receives read/write requests from the user, checks the cache to see if the data exists then performs the requested function; and
a post-processing thread that queues the read/write requests from the user.

5. The system according to claim 2 wherein the cache subsystem further comprises:
a cache thread that implements a hash cache to store user data blocks;
a memory allocation thread that evaluates the size of the user data blocks stored in the cache; and
a memory release thread that returns unused data blocks to the system.

6. The system according to claim 1 wherein each of the plurality of segments includes a user data area that contains user data blocks, a user data table that holds information about each of the user data blocks and a segment summary that contains meta data describing the segment.

7. The system according to claim 6 wherein the log structured driver writes global meta data to the segment summary that describes the information stored on the data storage device to at least one of the plurality of segments.

8. The system according to claim 1 wherein a traffic masking pattern further comprises removing jitter by delaying the read and write requests of the normal operation and data reclamation.

9. The system according to claim 1 wherein a traffic masking pattern further comprises adding false traffic to the read/write process to enhance the security of the system.

10. A method of secure data storage, the method comprising:
providing one or more data storage devices and an operating system interfacing with and controlling the one or more data storage devices;
providing a log structured driver interfacing with the operating system one or more storage devices;
creating a plurality of segments on the one or more data storage devices;
writing data to the plurality of segments using the log structured driver to encrypt the data is a secure manner; and
implementing a traffic masking pattern to obscure activity on the system from potential attackers.

11. The method according to claim 10 wherein the step of writing data using the log structured driver comprises the following steps:
initializing a load/unload subsystem that activates the log structured driver;
defining an association between the log structured driver and the one or more data storage devices using a configuration subsystem;
creating threads between the log structured driver and one or more data storage devices using an I/O subsystem; and
implementing a hash table that links blocks of user data to data in segments with a cache subsystem.

12. The method according to claim 11 further comprising the step of running a data reclamation subsystem when the number of free segments on the one or more storage devices falls below a predetermined level.

13. The method according to claim 11 wherein the step of creating threads using an I/O subsystem further comprises:
activating a pre-processing thread that receives read/write requests from the user, checks the cache to see if the data exists then performs the requested function; and
activating a post-processing thread that queues the read/write requests from the user.

14. The method according to claim 11 wherein the step of implementing a hash table with the cache subsystem further comprises:
implementing a cache thread to create a hash cache to store user data blocks;
implementing a memory allocation thread that evaluates the size of the user data blocks stored in the cache; and
implementing a memory release thread that returns unused data blocks to the system.

15. The method according to claim 10 wherein the step of creating a plurality of segments on the one or more data storage devices further includes the creation of a user data area that contains user data blocks, a user data table that holds information about each of the user data blocks and a segment summary that contains meta data describing the segment.

16. The method according to claim 15 wherein the step of writing data to the plurality of segments further includes writing global meta data to the segment summary that describes the information stored on the data storage device to at least one of the plurality of segments.

17. The method according to claim 10 wherein the step of implementing a traffic masking pattern further comprises removing jitter by delaying the read and write requests of the normal operation and data reclamation.

18. The method according to claim 10 wherein the step of implementing a traffic masking pattern further comprises adding false traffic to the read/write process to enhance the security of the system.

19. For use in secure data storage system, a log structured driver interfacing with one or more storage devices to secure data stored on one or more of a plurality of segments on the storage devices, the log structural driver comprising:
a load/unload subsystem that initializes activation of the log structured driver;
a configuration subsystem defining the information needed to provide the association between the log structured driver and the one or more data storage devices;
an I/O subsystem that creates threads between the log structured driver and one or more data storage devices;
a cache subsystem implementing a hash table that links blocks of user data to data in segments; and
a data reclamation subsystem that runs when the number of free segments on the one or more storage devices falls below a predetermined level.

20. The driver of claim 19 further comprising a traffic masking subsystem that obscures activity on the system from potential attackers by removing jitter by delaying the read and write requests of the normal operation and data reclamation and/or adding false traffic to the read/write process to enhance the security of the system.
